(19) United States
(12) Patent Application Publication
(10) Pub. No.: US 2025/0368583 A1
(43) Pub. Date: Dec. 4, 2025

(54) FERTILIZER CONTAINING A SOURCE OF COPPER

(71) Applicant: AGRA GROUP A.S., Strelske Hostice (CZ)

(72) Inventors: Petr CIGLER, Praha 6 (CZ); Pavel PLUHAR, Stare Mesto (CZ); Jaroslav MRAZ, Kremze (CZ)

(21) Appl. No.: 18/875,389

(22) PCT Filed: Jul. 1, 2023
(86) PCT No.: PCT/CZ2023/050037

§ 371 Date: Dec. 16, 2024

(30) Foreign Application Priority Data
Jul. 4, 2022 (CZ) PV 2022-298

(51) Int. Cl. C05D 9/02; C05C 5/02; C05G 5/27

(52) U.S. Cl. CPC C05D 9/02; C05C 5/02; C05G 5/27

(57) ABSTRACT

A fertilizer that includes Chevreul's salt, Cu₂SO₃·CuSO₃·2H₂O that enables copper to provided plants. Related fertilizer compositions and methods of nutrition of plants are also described.

### FIELD OF ART

The present invention relates to a fertilizer composition containing Chevreul's salt as a source of copper, and optionally containing other macronutrients and micronutrients, and to the use of Chevreul's salt for plant fertilization.

### BACKGROUND ART

Copper (Cu) is an essential element for a number of functions in the plant, such as chlorophyll production, protein synthesis and respiration. Copper deficiency in plant nutrition can lead to serious yield losses. Copper deficiency is manifested by yellowing and twisting of young leaves, curling of leaf tips, flaccidity and wilting when earing, damage to spikelets, bending of the grown top and stem, or melanosis of the stem. Therefore, copper-containing fertilizers are widely used to improve the yield and quality of agricultural crop production (Canadian Journal of Plant Science, 2006, 86 (3), 605-619).

Copper deficiency in crops is usually treated by applying copper sulfate salts or chelated forms of Cu²⁺, such as EDTA Cu²⁺ complexes, lignin sulfonates or citric acid. The composition, preparation and use of soluble fertilizers with copper content are covered, for example, in patents TR2017007417, WO2015036375, BR2010003875, PL213508, and PL212335.

All these fertilizers are water soluble and are therefore easily leached from the root zone or washed off the leaf surface after foliar application. Therefore, the doses of copper fertilizers are considerably excessive compared to the actual need, and the economics and ecology of using these fertilizers are not always favorable. E.g. copper sulfate is used when applied to the soil in doses of 3.5 to 15 kg Cu/ha. Copper oxychloride, which is a gradual release fertilizer, applied most often in the form of a suspension concentrate, is still used in high doses (up to 2 kg Cu/ha).

### DISCLOSURE OF THE INVENTION

An effective way to supply copper to plants is the use of slow-release fertilizers. The copper ions can be contained in the fertilizer in a chemical form in which they are insoluble, but are gradually released from this insoluble form by biological or chemical processes and thus become accessible to plants. The main problem is to find a form of copper that provides the right release rate that corresponds to plant consumption and thus allows to minimize the necessary dosage of copper for application.

One aspect of the invention is the use of Cu₂SO₃·CuSO₃·2H₂O (the so-called Chevreul's salt) as a fertilizer providing copper for plants.

An aspect of the invention is also a method of plant nutrition, comprising a step of applying Cu₂SO₃·CuSO₃·2H₂O to the seeds, the plant, the fruits or the soil.

Chevreul's salt (Cu₂SO₃·CuSO₃·2H₂O) contains copper in two oxidation states: Cu²⁺ and Cu⁺, and is a very water-insoluble substance. In the metallurgical industry, its low solubility is used for the hydrometallurgical separation of copper from solutions containing Cu²⁺ ions. The preparation, structure and properties of the Chevreul's salt are known (Silva L. A., Andrade J. B., J. Braz. Chem. Soc., 2004, 15 (2), 170-177). The substance can be prepared by several procedures, typically by reduction of Cu²⁺ compounds in an aqueous solution using S⁴⁺ compounds (SO₂, HSO₃⁻, SO₃²⁻, etc.) at elevated temperature (e.g. Calban T. et al., Chem. Eng. Comm. 2009, 196, 1018-1029).

Within the framework of the present invention, it has surprisingly been found that the very water-insoluble Chevreul's salt releases copper at the right rate for plant consumption, and supplies a sufficient amount of copper even at substantially lower application rates than the copper fertilizers currently used in the art.

Fertilizer compositions containing the compound Cu₂SO₃. CuSO₃·2H₂O typically contain solvents (especially water), surfactants, rheological modifiers, antioxidants, antifoaming agents, and optionally other auxiliary substances known in the art of formulation. Chevreul's salt can typically be contained in the fertilizer composition in the form of a suspension or in the form of particles.

The fertilizer composition can also contain one or more sources of nutrients N, P, K, Ca, Mg, S, B, Cl, Fe, Mn, Mo, Ni and Zn. Preferably, the nutrient sources (sources of nutrients) may be selected from: ammonium nitrate, potassium nitrate, calcium nitrate, calcium carbonate, magnesium carbonate, dolomitic limestone, urea, ammonium sulfate, calcium dihydrogen phosphate, calcium sulfate dihydrate, ammonium dihydrogen phosphate, potassium chloride, potassium sulfate, kainite (KCl·MgSO₄·3H₂O), magnesium sulfate, magnesium sulfate heptahydrate, magnesium sulfate monohydrate, ferrous sulfate, ferrous sulfate heptahydrate, Fe³⁺ complex with ethylenediaminetetraacetate (EDTA), boronic acid complex with ethanolamine, manganese (II) chloride, manganese (II) chloride dihydrate, manganese (II) chloride tetrahydrate, manganese (II) sulfate, manganese (II) sulfate monohydrate, manganese (II) sulfate tetrahydrate, ammonium molybdate, sodium molybdate, nickel sulfate, nickel sulfate hexahydrate, nickel sulfate heptahydrate, zinc sulfate, Zn²⁺ complex with EDTA, zinc sulfate hexahydrate, zinc sulfate heptahydrate.

The fertilizer composition according to the invention may preferably contain one or more sources of nutrients N, K, S, B, and Zn. More preferably, the fertilizer composition contains one or more of: ammonium nitrate, potassium nitrate, calcium nitrate, urea, ammonium sulfate, potassium sulfate, magnesium sulfate heptahydrate, boric acid complex with ethanolamine, Zn²⁺ complex with EDTA.

Surfactants include dispersing agents, wetting agents and emulsifying agents of ionic or non-ionic nature. Examples can be salts of naphthalenesulfonic, phenolsulfonic and ligninsulfonic acids, polycondensates of ethylene oxide with fatty alcohols or amines, substituted phenols (preferably alkylphenols and arylphenols), salts of sulfosuccinic acid esters, salts of alkylbenzenesulfonic acid, taurine derivatives (preferably alkyltaurates), polyethylene glycol sorbitan monolaurate, polyethylene glycol sorbitan monopalmitate, polyethylene glycol sorbitan monostearate, polyethylene glycol sorbitan monooleate, phosphoric acid esters with polyethoxylated alcohols or phenols, fatty acid esters with polyols and derivatives of the aforementioned compounds containing a sulfate, sulfonate or phosphate functional group. The surfactant content in the mixture can preferably be within the range of 2 to 50 wt. %.

An antioxidant is any substance suitable for use in agriculture that has the ability to stabilize the compound CuzSO₃·CuSO₃·2H₂O against oxidation. It is preferred to use compounds containing S⁴⁺, e.g. NaHSO₃, Na₂SO₃, Na₂S₂O₅ or K₂S₂O₅. The antioxidant content in the fertilizer may preferably be within the range of 0.01 to 10 wt. %.

An antifoaming agent (or defoamer) is any substance that reduces foam stability. Silicone-based compounds are particularly preferred.

Auxiliary substances are colloidal stabilizers, adhesives, binders and rheological modifiers. Preferred auxiliary substances are selected from the group: hydroxypropyl cellulose, hydroxypropyl methylcellulose, methylcellulose, ethylmethylcellulose, ethylcellulose, carboxymethylcellulose, hydroxyethyl cellulose, hydroxyethyl methylcellulose, polyvinylpyrrolidone, polyvinyl alcohol, betaine, mannitol, sorbitol, glycerol. In general, Cu₂SO₃·CuSO₃·2H₂O can be combined with any liquid or solid auxiliary substance commonly used in fertilizer formulation.

The fertilizer composition according to the invention preferably contains 1 to 99 wt. % of Cu₂SO₃·CuSO₃·2H₂O. When formulated as a wettable powder or as water-dispersible granules, the fertilizer composition preferably contains 10 to 95 wt. %, more preferably 40 to 95 wt. %, or 40 to 80 wt. %, of CuzSO₃·CuSO₃·2H₂O. When formulated as a suspension concentrate, the fertilizer composition preferably contains 1 to 50 wt. %, more preferably 5 to 30 wt. %, of Cu₂SO₃·CuSO₃·2H₂O.

The fertilizer compositions according to the invention may be prepared in various forms suitable directly or after dilution for application in agriculture, such as e.g. granules or microgranules dispersible in water, wettable powders, tablets dispersible in water, suspensions, suspension concentrates, pastes dispersible in water, emulsifiable powders, emulsifiable granules or microgranules, emulsifiable suspension concentrates, microemulsions, colloidal solutions containing nano- or microparticles of Cu₂SO₃·CuSO₃·2H₂O. Wettable powders can be filled into soluble packagings, the use of which prevents undesirable dusting and possible inhalation by the user.

For the above-mentioned applications, Chevreul's salt Cu₂SO₃. CuSO₃·2H₂O should preferably have a particle size smaller than 40 μm, preferably smaller than 8 μm, in an even more preferred embodiment smaller than 4 μm, and most preferably up to 2 μm, as determined using laser diffraction (Sympa TEC HELOS/KR). The particle sizes correspond to the hydrodynamic average diameter of the particles determined in the measured dispersion.

In some embodiments, the fertilizer composition according to the invention may further contain further active substances, such as insecticides, fungicides, bactericides, attractants, acaricides, pheromones and other biologically-active substances. The content of further active substances may increase the effectiveness of the fertilizer.

The fertilizer compositions according to the invention may be used to fertilize plants (to supply copper to plants) by applying it to the plants, to their seeds, fruits or to the soil where the plants grow. Crops that can be fertilized by the fertilizer composition include cotton, flax, grapevines, crops from the Rosaceae family (e.g. apple and pear trees, apricots, almonds and peaches, strawberries), Ribesioidae, Juglandaceae, Betulaceae, Anacardiaceae, Fagaceae, Moraceae, Oleaceae, Actinidaceae, Lauraceae, Musaceae, Rubiaceae, Theaceae, Sterculiceae, Rutaceae (e.g. lemon, orange and grapefruit), Solanaceae (e.g. tomato, potatoes, peppers), Liliaceae, Asteraceae (e.g. chives), Umbelliferae, Cruciferae, Graminae (e.g. maize, grass or cereals such as wheat, barley, oats, rye or triticale), Asteraceae (e.g. sunflower), Poaceae (e.g. rice, sorghum), Cucurbitaceae (e.g. cucumber, pumpkin, melon, squash), Brassicaceae (e.g. cabbage), Cruciferae (e.g. canola), Apiaceae (e.g. carrot, parsley, celery), Alliaceae (e.g. onion), Fabacae (e.g. groundnut), Papilionaceae (e.g., soybeans, lentils, peas, beans), Chenopodiaceae (e.g. sugar beet, spinach); in general agricultural, technical and forest crops and their genetically modified homologues.

The fertilizer composition according to the invention can be preferably used for fertilization of (supplying copper to) cereals, corn, rapeseed, mustard, poppy, sunflower, potatoes, sugarcane, legumes, vines, hops, fruit vegetables and root vegetables.

In a particularly preferred embodiment, the fertilizer is in the form of a suspension concentrate and contains 5 to 30 wt. % Cu₂SO₃·CuSO₃·2H₂O, 1 to 10 wt. % surfactant, 1 to 10 wt. % auxiliary substance(s) and solvent. The solvent is preferably water.

The dose of Cu₂SO₃·CuSO₃·2H₂O expressed as a dose of Cu during foliar application can be in the range of 5 to 750 g/ha, preferably 10 to 250 g/ha, in an even more preferred embodiment 25 to 150 g/ha.

### EXAMPLES OF CARRYING OUT THE INVENTION

### Example 1

Preparation of Suspension Concentrate Containing Cu₂SO₃·CuSO₃·2H₂O (Fertilizer Composition A1)

Chevreul's salt and the auxiliary substances listed in Table 1 were combined with water and the mixture was milled using the laboratory mill Dyno-mill Multi-lab (Soremat) until the particle size was less than 2 μm. A stable dispesion was obtained which forms the fertilizer composition A1. The composition A1 contains 50 g/dm³ Cu. The particle size was determined by laser diffraction using the apparatus Sympa TEC HELOS/KR. The particle size value represents the hydrodynamic diameter of the particles in the interval X90.

TABLE 1
Fertilizer composition A1.

| Compound/Substance | wt. % |
|---|---|
| Cu₂SO₃•CuSO₃•2H₂O | 9.5 |
| Polyvinylpyrrolidone | 2.0 |
| Hydroxypropyl cellulose | 1.0 |
| Polyethylene glycol sorbitan | 2.0 |
| monolaurate (Tween 20) | |
| Water | 85.5 |

### Example 2

Preparation of the Suspension Concentrate Containing Cu₂SO₃·CuSO₃·2H₂O and Further sources of Nutrients (Fertilizer Composition A4)

Chevreul's salt and the auxiliary substances listed in Table 2 were mixed with water and the mixture was milled using a Dyno-mill Multi-lab (Soremat) until the particle size was less than 2 μm. The particle size was determined as in Example 1. A stable dispersion of fertilizer composition A2 was obtained.

The sources of nutrients listed in Table 3 were dissolved in water to obtain fertilizer composition A3.

The final stable dispersion of fertilizer A4 was obtained by mixing fertilizer compositions A2 and A3 in a weight ratio of 0.579:0.421. The resulting fertilizer composition A4 contained 50 g/dm³ of Cu.

TABLE 2
Fertilizer composition A2.

| Compound/Substance | wt. % |
|---|---|
| Cu₂SO₃•CuSO₃•2H₂O | 15 |
| Polyvinylpyrrolidone | 2 |
| Hydroxypropyl methyl cellulose | 1 |
| Polyethylene glycol sorbitan | 2 |
| monolaurate (Tween 20) | |
| Water | 80 |

TABLE 3
Fertilizer composition A3.

| Compound/Substance | wt. % |
|---|---|
| Potassium nitrate | 15.5 |
| Boric acid complex wtih ethanolamine | 16.6 |
| Zn-EDTA | 14.3 |
| Betaine hydrochloride | 0.6 |
| Water | 53.0 |

TABLE 4
Fertilizer composition A4

| Compound/Substance | wt. % |
|---|---|
| Cu₂SO₃•CuSO₃•2H₂O | 8.70 |
| Polyvinylpyrrolidone | 1.16 |
| Hydroxypropyl methyl cellulose | 0.58 |
| Polyethylene glycol sorbitan | 1.16 |
| monolaurate (Tween 20) | |
| Potassium nitrate | 6.63 |
| Boric acid complex with ethanolamine | 6.99 |
| Zn-EDTA | 6.02 |
| Betaine hydrochloride | 0.25 |
| Water | 68.61 |

### Example 3

It was tested whether the fertilizer composition according to the invention containing Chevreul's salt as an active ingredient is taken up by the leaves at a comparable level as the water-soluble chelate form of Cu²⁺. Therefore, under identical conditions, the same doses of copper in these two different forms were applied and the uptake of copper by plants was compared. The model crop was oilseed rape (Brassica napus subsp. napus L.), a winter form. The experiment was a small-plot experiment, where one application plot measured 4 m², each variant of copper source was tested on two plots, and a mixed plant sample was taken for analysis from both plots. Two fertilizer compositions (with different copper sources) were compared:
1) fertilizer composition A1 prepared in Example 1, containing a stabilized suspension of Chevreul's salt as the only source of Cu,
2) fertilizer composition A5 containing 5 wt % aqueous solution of water-soluble Cu²⁺ complex with EDTA as the only source of Cu.

The concentration of Cu in both fertilizer compositions was the same (50 g/dm³). Plants not fertilized with any fertilizer were used as a control. The application was carried out with a hand sprayer at a dose of 2 1/ha in the growth phase of rapeseed BBCH=16 (sixth full leaf developed).

Plant samples were collected on the 10th day after fertilizer composition application, and the aerial parts of the plants were thoroughly rinsed in 0.01% HCl to wash away any unabsorbed Cu. The weight of the dry matter of the aerial part of the plants was determined and the content of Cu in the dry matter was determined using atomic absorption spectrometry. The results of the analysis are summarized in Table 5.

TABLE 5
Amount of Cu in dry matter of oilseed rape

| | | | Composition |
|---|---|---|---|
| | | Composition A1 | A5 (complex |
| Variant | Control | (Chevreul's salt) | Cu²⁺ with EDTA) |
| Cu content | 10.4 | 20.0 | 21.0 |
| (mg/kg dry matter) | | | |

The results show that the uptake of copper by leaves from both fertilizer compositions A1 and A5 is comparable, i.e. when a water-soluble copper compound is applied, the plant receives a comparable amount of copper as from the water-insoluble Chevreul's salt, which was applied in the form of particles.

### Example 4

In this example, the effect of fertilizer composition A4 prepared in Example 2, containing Chevreul's salt as an active ingredient, was tested on common wheat.

The experiment was performed as a precise vegetation container experiment in a vegetation hall. The model crop was common wheat (Triticum aestivum L.), variety Julia. Individual variants were established in 6 repetitions, 15 plants per container. Each container contained soil at a weight of 1500 g/container. The characteristics of the soil are shown in Table 6. After sowing, uniform watering was ensured for all variants throughout the vegetation period.

TABLE 6
Characteristics of the soil used for the experiment

| Soil parameter | Value | |
|---|---|---|
| pH (CaCl₂) | 6.09 | |
| Oxidable carbon (Cₒₓ) | 0.80% | |
| Clay | 20% | |
| Dust | 27% | |
| Sand | 53% | |
| Cation-exchange capacity | 164 | mmol/kg |
| N (total content) | 0.19% | |
| P (Mehlich 3 method) | 36.4 | mg/kg |
| K (Mehlich 3 method) | 400 | mg/kg |
| Ca (Mehlich 3 method) | 2 720 | mg/kg |
| Mg (Mehlich 3 method) | 214 | mg/kg |

Fertilizer composition A4 containing a suspension formulation of Chevreul's salt was applied to the plants. The fertilizer composition was applied off the root with a sprayer at the beginning of vegetation (at 2-3 leaves) in a concentration of 2 1 of fertilizer/250 1 of water (3 ml of solution per container). Plants not fertilized with any fertilizer were used as a control.

The monitored parameters were measured at weekly intervals. After the end of the experiment, the relative content of chlorophyll in the leaves of the plants was measured (expressed as the values given by the Yara N-Tester device), and the electric capacity of the root system, which corresponds to the size of the plant root system, was determined using the LCR multimeter ESCORT ELC-131D. After that, the aerial part of each plant was thoroughly rinsed in 0.01% HCl to wash away the unabsorbed amount of nutrients. The weight and dry matter content of the aerial parts of the plants were determined and a standard inorganic analysis of the plants was carried out (determination of N content by Dumas method, P content by absorption photometry, and Cu, K, Ca, and Mg content by atomic absorption spectrometry).

The measurement results were evaluated by statistical methods (STATISTICA 12) using one-factor ANOVA followed by Fischer's test (LSD test) at a 95% significance level (p<0.05).

### Results

### A) Inorganic Analysis

After the application of fertilizer composition A4 according to the invention, there was a significant increase (p≤0.05) in the content of Cu in wheat, 7.1 times compared to the unfertilized variant, which was on the verge of Cu deficiency (Table 7). This result demonstrates the high efficiency of the fertilizer composition A4 as a source of Cu for wheat. A slight increase in nitrogen and potassium content in plants was observed as a beneficial phenomenon. The contents of the other monitored nutrients were not significantly affected.

TABLE 7
Results of inorganic analysis of wheat dry matter after
application of the fertilizer composition A4 vs. control

| | Cu content | Nutrient content (wt. % of dry matter) | | | | |
|---|---|---|---|---|---|---|
| Variant | (mg/kg) | N | P | K | Ca | Mg |
| Control | 4.29 ± 0.16 | 2.84 | 0.25 | 4.21 | 0.33 | 0.11 |
| Composition A4 | 30.42 ± 2.42 | 3.07 | 0.24 | 4.69 | 0.30 | 0.10 |

### B) Plant Weight and Production of Dry Matter

The application of the fertilizer composition A4 led to a significant increase (p≤0.05) in the total production of dry matter and in its content (Table 8). This result shows the beneficial properties of Chevreul's salt in removal of Cu deficiency in wheat.

TABLE 8
Yields of dry matter of wheat and its content after application
of the fertilizer according to the invention

| | Aerial part | Plant |
|---|---|---|
| | dry matter | dry matter |
| Variant | (g/container) | (%) |
| Control | 2.13 ± 0.09 | 17.03 ± 0.54 |
| Composition A4 | 2.28 ± 0.07 | 18.23 ± 0.39 |

### C) Chlorophyll Content

The application of the fertilizer composition A4 led to a significant increase (p≤0.05) in the chlorophyll content, expressed as a relative value indicated by the Yara N-tester, by 16% (Table 9). This result shows the positive effect of the fertilizer of the invention on plant metabolism and vitality.

TABLE 9
N-tester values after application of the
fertilizer according to the invention

| Variant | N-tester value | rel. % |
|---|---|---|
| Control | 511 | 100 |
| Composition A4 | 593 | 116 |

### D) Electrical Capacity of the Root System

The electrical capacity of the root system (expressed in nanofarads, nF) is a measure of the active surface of the roots. Living plant tissue reacts to the passage of an electric current as a capacitor (it can temporarily accumulate the electric charge) and its parallel electric capacity can be measured. It corresponds, in addition to the size of the active root system, also to the membrane vitality of the cells.

The application of the fertilizer composition A4 according to the invention led to a significant increase (p≤0.05) in the electrical capacity of the root system by 26% (Table 10). This result shows the positive effect of fertilizer of the invention on the growth of the root system and plant vitality.

TABLE 10
Size of the root system measured with an LCR meter after the
application of the fertilizer according to the invention

| | Electrical capacity | |
|---|---|---|
| Variant | of root system (nF) | rel. % |
| Control | 1.55 | 100 |
| Composition A4 | 1.95 | 126 |

### Example 5

The effect of the fertilizer composition A4 prepared in Example 2, containing Chevreul's salt as an active ingredient, was tested on corn.

The experiment was performed as a precise vegetation container experiment in controlled temperature conditions of a greenhouse (day temperature 20° C./12 h, night temperature 10° C./12 h). The model crop was corn (Zea mays L.), variety SY Orpheus. Individual variants were established in 6 repetitions, 3 plants per container. Each container contained soil at a weight of 1500 g/container, the soil having the same characteristics as shown in Example 4, Table 6. After sowing, uniform watering was ensured for all variants throughout the vegetation period.

Fertilizer composition A4 was applied foliarly with a sprayer at the beginning of vegetation (at 2-3 leaves) in a concentration of 2 1 of fertilizer/250 1 of water (3 ml of solution per container). Plants not fertilized with any fertilizer were used as a control. After the end of the experiment, the aerial part of each plant was thoroughly rinsed in 0.01% HCl to wash away any unabsorbed nutrients. The weight and dry matter content of the aerial parts of the plants were determined and a standard inorganic analysis of the plants was carried out similarly as in Example 4. The statistical evaluation of the monitored parameters was carried out analogously to the experiment presented in Example 4.

### Results

### A) Inorganic Analysis

After the application of the fertilizer composition A4, there was a significant increase (p≤0.05) in the content of Cu in corn (maize), 5.5 times compared to the unfertilized variant (Table 11). This result shows the high efficiency of the fertilizer of the invention as a source of Cu for corn. The contents of the other monitored nutrients were not significantly affected.

TABLE 11
Inorganic analysis of corn dry matter after application
of the fertilizer according to the invention

| | | Nutrient content | | | |
|---|---|---|---|---|---|
| | Cu content | (wt. % of dry matter) | | | |
| Variant | (mg/kg) | P | K | Ca | Mg |
| Control | 2.49 ± 0.26 | 0.12 | 4.42 | 0.39 | 0.16 |
| Composition A4 | 13.71 ± 1.54 | 0.11 | 4.31 | 0.37 | 0.16 |

### B) Plant Weight and Dry Matter Production

The application of the fertilizer composition A4 led to an increase in the total production of corn dry matter and its content (Table 12).

TABLE 12
Corn dry matter yield and its content after application
of the fertilizer according to the invention

| | Aerial part | Plant |
|---|---|---|
| | dry matter | dry matter |
| Variant | (g/container) | (%) |
| Control | 4.45 ± 0.59 | 12.92 ± 1.04 |
| Composition A4 | 4.76 ± 0.39 | 13.05 ± 0.50 |

### Example 6

### Preparation of Wettable Powder and Water Dispersible Granule Formulations (Fertilizer Compositions A6 and A7)

Chevreul's salt with a particle size of less than 2 μm and the excipients listed in Table 13 (amounts correspond to the column Preparation) were mechanically mixed and homogenized. The resulting paste was spread into a thin layer onto a drying mat and dried for 4 hours in a laboratory drying oven at 50° C. in an inert nitrogen atmosphere. After drying, the layer had the composition shown in Table 13 (column After drying).

TABLE 13
Preparation and composition of fertilizers A6 and A7

wt. %

| | | After drying |
|---|---|---|
| | | (final composition |
| | | of the fertilizers |
| Component | Preparation | A6 and A7) |
| Cu₂SO₃•CuSO₃•2H₂O | 63.0 | 94.0 |
| Zephrym PD 3315 (Croda) * | 10.0 | 5.3 |
| Water | 27.0 | 0.7 |

* Zephrym PD 3315 is a polymeric surfactant supplied as 35 wt % solution.

The dried layer was transferred from the drying mat to a laboratory sieve with sieves placed underneath each other with a mesh size of 850 μm (sieve No. 20 according to the ASTM standard), 425 μm (sieve No. 40 according to the ASTM standard) and 150 μm (sieve No. 100 according to the standard ASTM). After finishing sieving, two size fractions representing two fertilizers were obtained, labeled A6-wettable powder (fraction that passed sieve No. 100) and A7—granules dispersible in water (fraction that passed sieve No. 40 but not sieve No. 100).

1. A fertilizer comprising Cu₂SO₃·CuSO₃·2H₂O for providing copper for plants.

2. A method of providing plant nutrition, comprising a step of applying Cu₂SO₃·CuSO₃·2H₂O to seeds, plant, fruits or soil.

3. A fertilizer composition for fertilizing plants, comprising Cu₂SO₃·CuSO₃·2H₂O and at least one auxiliary substance selected from: solvents, surfactants, rheological modifiers, antioxidants, antifoaming agents.

4. The fertilizer composition according to claim 3, which further comprises at least one nutrient source wherein the nutrient is selected from: N, P, K, Ca, Mg, S, B, Cl, Fe, Mn, Mo, Ni and Zn.

5. The fertilizer composition according to claim 4, wherein the nutrient source is selected from the group consisting of ammonium nitrate, potassium nitrate, calcium nitrate, calcium carbonate, magnesium carbonate, dolomitic limestone, urea, ammonium sulfate, calcium dihydrogen phosphate, calcium sulfate dihydrate, ammonium dihydrogen phosphate, potassium chloride, potassium sulfate, kainite, magnesium sulfate, magnesium sulfate heptahydrate, magnesium sulfate monohydrate, ferrous sulfate, ferrous sulfate heptahydrate, Fe³⁺ complex with ethylenediaminetetraacetate, boronic acid complex with ethanolamine, manganese (II) chloride, manganese (II) chloride dihydrate, manganese (II) chloride tetrahydrate, manganese (II) sulfate, manganese (II) sulfate monohydrate, manganese (II) sulfate tetrahydrate, ammonium molybdate, sodium molybdate, nickel sulfate, nickel sulfate hexahydrate, nickel sulfate heptahydrate, zinc sulfate, Zn²⁺ complex with ethylenediaminetetraacetate, zinc sulfate hexahydrate, zinc sulfate heptahydrate.

6. The fertilizer composition according to claim 3, which is in the form of a wettable powder or water-dispersible granules and comprises 10 to 95 wt. % Cu₂SO₃·CuSO₃·2H₂O.

7. The fertilizer composition according to claim 3, which is in the form of a suspension concentrate and comprises 1 to 50 wt. % Cu₂SO₃·CuSO₃·2H₂O.

8. The fertilizer composition according to claim 3 wherein Cu₂SO₃·CuSO₃·2H₂O has a particle size up to 40 pm.

9. The fertilizer composition according to claim 3 wherein Cu₂SO₃·CuSO₃·2H₂O has a particle size up to 8 pm.

10. The fertilizer composition according to claim 3 wherein Cu₂SO₃·CuSO₃·2H₂O has a particle size up to 4 pm.
